(19) United States
(12) Patent Application Publication
(10) Pub. No.: US 2023/0041106 A1
(43) Pub. Date: Feb. 9, 2023

(54) BLIND IDENTIFICATION OF CHANNEL TAP NUMBERS IN WIRELESS COMMUNICATION

(71) Applicant: Istanbul Medipol Universitesi, Istanbul (TR)

(72) Inventors: Ahmad Mohammad Abd-Alghani JARADAT, Istanbul (TR); Hüseyin ARSLAN, Istanbul (TR); Mehmet Kemal ÖZDEM?R, Istanbul (TR); Khaled ELGAMMAL, Istanbul (TR)

(21) Appl. No.: 17/789,304

(22) PCT Filed: Dec. 2, 2020
(86) PCT No.: PCT/TR2020/051214

§ 371 Date: Jun. 27, 2022

(30) Foreign Application Priority Data
Dec. 30, 2019 (TR) 2019/22365

(51) Int. Cl. H04L 25/02

(52) U.S. Cl. CPC H04L 25/0238; H04L 25/0254

(57) ABSTRACT

The present disclosure relates to a method for blind identification of channel tap numbers in wireless communication by using deep neural networks (DNN). In the proposed method, it is possible to train a DNN using only the transmitted and received signals of a wireless system in order to obtain the number of channel taps. We propose a robust and efficient sparse representation technique for the identification of wireless channels. We estimate the number of channel taps which is considered as one of the sparse features of the hannel The blind estimation performed in the proposed system, enhances the spectral efficiency of the used wireless communication system since the employed DNN does not require to transmit extra signals for identifying the channel taps. In our identification method, physical insights are not available or used.

### TECHNICAL FIELD

The present disclosure relates to a method for blind identification of channel tap numbers in wireless communication by using deep neural networks (DNN).

### BACKGROUND

The structure of the communication frameworks fundamentally depends on channel models that describe genuine situations verifiable for scientific accommodation. To model a realistic channel accurately, new structures and features are needed to be extracted from the measurement dataset. A critical feature in wireless channel model is to find the most convenient number of channel taps. The knowledge of the appropriate number of wireless channel taps using a transmitted signal and a received signal only, does not depend on pre-assumed scenarios in an unknown channel.

In the state of the art, information about the number of taps of wireless channels can only be achieved by prior assumptions. For example, Xiao Z. et al. (2014) proposes a method using prior assumptions which non-line of sight (NLOS) identification and mitigation problems are solved using multiple received signal strength (RSS) measurements from WiFi signals. Li A. et al. (2015) also suggests an identification method with prior assumptions. Unlike traditional demodulation-based identification method, this document proposes a “demodulation-free protocol identification”. In this method, only features of physical layer samples are used. Li D. et al. (2017) suggests a channel identification algorithm based on feature extraction. In this method, different characteristics of wireless channel are extracted based on arrival time and signal strength, such as the number of multipath, time delay and delay spread etc.

As it can be seen, there is no blind identification method, in state of the art, that can identify wireless channel without prior assumptions. Thus, achieving information about the number of channel taps in a wireless network, without prior assumptions, is essential especially for 5G and beyond networks.

In the state of the art, CN109525369 numbered patent document discloses a channel coding type blind recognition method based on cyclic neutral network. This document suggests extracting the characteristics of the received related sequences by adequately utilizing the cyclic neural network. In the identification process, by dividing a long string of sequences for segmented recognition and making the final decision on the sequences by using the principle of the minority obeying the majority. This document proposes a network model for automatically extracting characteristics of the related sequences, thus cumbersome process of manually extracting characteristics is avoided which greatly saves the labour cost, simplifies the steps of characteristics extraction and improves the accuracy of recognition of the coded sequences. However, the method proposed in this document require overheads, such as dividing long strings of sequences for segmented recognition and making the final decision on the sequences by using the principle of the minority obeying the majority.

Further, identifying channel taps numbers cannot be achieved without recognizing coded sequences. Moreover, the method stated in this document does not consider an efficient maximally sparse representation.

Thus, a method that doesn't require the overheads and can blindly identify the channel taps numbers is required. Besides, this method should exploit a deep neural network that creates a robust and efficient maximally sparse representation for the identification of wireless channels.

### SUMMARY

The invention aims to provide a precise model for wireless channels, which is very important in designing and evaluating wireless communication systems. In this model, the numerical methods for the communication channels are completely obscure, so it can be applied to any type of channel without the need for a prior analysis.

Deep learning (DL), as an emerging tool, offers framework to be exploited by many different fields. It is anticipated that the DL-based communication systems will be useful under certain circumstances such as quickly changing channel parameters. The deep neural networks (DNNs) can investigate the complicated features of channels such as the number of complex wireless channel taps.

In the proposed method, it is possible to train a DNN using only the transmitted and received signals of a wireless system in order to obtain the number of channel taps. We propose a robust and efficient sparse representation technique for the identification of wireless channels. We estimate the number of channel taps which is considered as one of the sparse features of the channel. The blind estimation performed in the proposed system, enhances the spectral efficiency of the used wireless communication system since the employed DNN does not require to transmit extra signals for identifying the channel taps. In our identification method, physical insights are not available or used.

### DETAILED DESCRIPTION

The invention proposes a method for blind identification of the number of channel taps in wireless communication comprising the steps of:
a. importing channel samples from the real-world channel datasets,
b. modifying an existing DNN and analysing its performance in terms of training, validation loss and accuracy
c. selecting the basic structure, stated in Xin B. et al. (2016), comprising;
   i. using the feed-forward design that has fully-connected layers with residual connections and batch normalization
   ii. including a final ‘softmax’ layer in order to provide normalized probabilities of input signals belonging to classes and
   iii. incorporating Dropout layers to the deep neural network stated in Xin B. et al. (2016),
d. training the employed DNN with an optimizer
e. sending the transmitted signals through different wideband frequency selective channels with the generated CIR of length corresponding to the number of multipath components
f. using the transmitted and received signals with their corresponding number of channel taps as training dataset.

In a preferred embodiment, said real-world channel datasets are generated using a simulator. For example, MATLAB-based NYUSIM simulator (2016) could be used as also suggested by Samimi, M. K. & Rappaport T. S. (2016) and Sun S. et al. (2016). As Sun S. et al. (2016) suggest, the preference found in NYUSIM is that it can support broad set of frequencies, beamwidths, bandwidths, wireless channel scenarios, etc. The simulation parameters used in our implementation are similar to that of the default simulation setup described in NYUSIM simulator (2016) for spatial channel model using NYUSIM.

In the example implementation, we select the basic structure proposed by Xin B. et al. (2016) due to its memory and computation efficiency and the ability to employ it on various heterogeneous systems.

Last but not least, in order to avoid overfitting, regularization is applied in a preferred embodiment.

### REFERENCES

[1] New York University, NYUSIM, 2016. [Online]. Available: http://wireless.engineering.nyu.edu/5gmillimeter-wave-channel-modeling-software/.

[2] M. K. Samimi and T. S. Rappaport, “3-D Millimeter-Wave Statistical Channel Model for 5G Wireless System Design,” in IEEE Transactions on Microwave Theory and Techniques, vol. 64, no. 7, pp. 2207-2225, July 2016.

[3] S. Sun et al., “Investigation of Prediction Accuracy, Sensitivity, and Parameter Stability of Large-Scale Propagation Path Loss Models for 5G Wireless Communications,” in IEEE Transactions on Vehicular Technology, vol. 65, no. 5, pp. 2843-2860, May 2016.

[4] Bo Xin, Yizhou Wang, Wen Gao and David Wipf. Maximal sparsity with deep networks arXiv preprint arXiv: 1605.01636, 2016

[5] Z. Xiao, H. Wen, A. Markham, N. Trigoni, P. Blunsom, and J. Frolik, “Non-line-of-sight identification and mitigation using received signal strength,” IEEE Transactions on Wireless Communications, vol. 14, no. 3, pp. 1689-1702, 2014.

[6] A. Li, C. Dong, S. Tang, F. Wu, C. Tian, B. Tao, and H. Wang, “Demodulation-free protocol identification in heterogeneous wireless networks,” Computer Communications, vol. 55, pp. 102-111, 2015.

[7] Dengao Li, Gang Wu, Jumin Zhao, Wenhui Niu, and Qi Liu, “Wireless Channel Identification Algorithm Based on Feature Extraction and BP Neural Network,” Journal of Information Processing Systems, vol. 13, no. 1, pp. 141-151, 2017.

1. A method for blind identification of the number of channel taps in wireless communication comprising the steps of:
a. importing channel samples from the real-world channel datasets,
b. modifying an existing DNN and analysing its performance in terms of training, validation loss and accuracy
c. selecting the basic structure comprising;
i. using the feed-forward design that has fully-connected layers with residual connections and batch normalization
ii. including a final ‘softmax’ layer in order to provide normalized probabilities of input signals belonging to classes and
iii. incorporating Dropout layers to the deep neural network
d. training the employed DNN with an optimizer
e. sending the transmitted signals through different wideband frequency selective channels with the generated CIR of length corresponding to the number of multipath components
f. using the transmitted and received signals with their corresponding number of channel taps as training dataset.

2. A method for blind identification of the number of channel taps in wireless communication according to claim 1, wherein said real-world channel datasets are generated using a simulator.

3. A method for blind identification of the number of channel taps in wireless communication according to claim 1, further comprising the step of applying regularization.
